(19) United States
(12) Patent Application Publication
(10) Pub. No.: US 2009/0101293 A1
(43) Pub. Date: Apr. 23, 2009

(54) LIGHT-BLOCKING HEADRAIL FOR ARCHITECTURAL COVERING

(75) Inventors: Richard N. Anderson, Whitesville, KY (US); Donald E. Fraser, Owensboro, KY (US); Stephen R. Haarer, Maceo, KY (US); Eugene Thompson, Maceo, KY (US)

Correspondence Address: MERCHANT & GOULD PC, P.O. BOX 2903, MINNEAPOLIS, MN, 55402-0903, US

(73) Assignee: Hunter Douglas, Inc., Upper Saddle River, NJ (US)

(21) Appl. No.: 12/255,473

(22) Filed: Oct. 21, 2008

Related U.S. Application Data
(60) Provisional application No. 60/981,684, filed on Oct. 22, 2007.

(51) Int. Cl. E06B 9/00; A47B 96/06

(52) U.S. Cl. 160/368.1; 248/208

(57) ABSTRACT

A light-blocking head-rail, and architectural coverings incorporating the headrail, include a light-blocking strip adapted to block out light. Embodiments of the light-blocking strip include bristles which tend to block substantially all of the light that might otherwise pass between a top surface of the headrail and a top beam of an architectural opening. The bristles can conform and fill in gaps between the top surface of the headrail and the top beam, and can further be compressed by a bracket connecting the headrail to the top beam of the architectural opening. Additional embodiments of the light-blocking strip are made from a flexible material that can be easily deflected and compressed when installed within an architectural opening.

### CROSS-REFERENCE TO RELATED APPLICATION

This application claims priority to U.S. Provisional Patent Application No. 60/981,684 entitled “LIGHT-BLOCKING HEADRAIL FOR ARCHITECTURAL COVERING” filed Oct. 22, 2007, which is hereby incorporated by reference in its entirety as if set forth herein in full. This application also claims priority to U.S. Design patent application No. 29/283,533 entitled “HEADRAIL FOR ARCHITECTURAL COVERING” filed Aug. 16, 2007, which is also hereby incorporated by reference in its entirety as if set forth herein in full.

### BACKGROUND

Coverings for windows or other architectural openings include products such as Venetian blinds, collapsible shades, and the like. Such coverings typically include a headrail in which a portion of the covering is stored when the covering is in a retracted position. A headrail may also contain mechanisms for sliding a vertical blind between open and closed positions. The headrail is typically mounted at the top of an architectural opening (e.g., a top horizontal beam of a door or window) via brackets that are releasably connected to the headrail to facilitate mounting and removal of the headrail within the architectural opening.

When a headrail is mounted in an architectural opening, a standoff or gap is created between a top beam of an architectural opening and the top surface of the headrail. This gap allows light to pass through the opening and over the top of the headrail, creating undesirable light leakage above the headrail even when the covering is closed.

It is with respect to these and other background considerations, limitations and problems that the present invention has evolved.

### SUMMARY

Described are embodiments for a light-blocking head-rail for an architectural covering and architectural covering incorporating the headrail. The headrail includes a light-blocking strip adapted to block out light. In some embodiments, the light-blocking strip includes bristles which tend to block substantially all of the light that might otherwise pass between a top surface of the headrail and a top beam of an architectural opening. The bristles can conform and fill in gaps between the top surface of the headrail and the top beam. In other embodiments, the light-blocking headrail does not include bristles but includes flexible material that may be compressed to fill in gaps between the top surface of the headrail and the top beam of an architectural opening.

This Summary is provided to summarize some embodiments of the present invention that are further described below in the Detailed Description. This Summary is not intended to identify important or essential features, nor is it intended to be used to limit the scope of the claims.

### BRIEF DESCRIPTION OF THE DRAWINGS

FIG. 1 illustrates a headrail in accordance with an embodiment of the present invention.

FIG. 2 illustrates the headrail shown in FIG. 1 with a light-blocking strip detached from the headrail.

FIG. 3 illustrates the headrail shown in FIG. 1 with attached mounting brackets, in accordance with the present invention.

FIG. 4 illustrates the headrail shown in FIG. 1 installed within a window frame in accordance with the present invention.

FIG. 5 illustrates a section view of FIG. 4.

FIG. 6 illustrates an enlarged section view of FIG. 4 showing the top portion of the headrail.

### DETAILED DESCRIPTION

The present invention relates to an improved headrail for an architectural covering that provides a seal to substantially prevent light leakage between a top portion of the headrail and an adjacent beam (e.g., a top window jamb). The description below describes the mounting of a headrail within an architectural opening using brackets that are attached to a top jamb of the architectural opening. It should be understood however that the present invention is not so limited. In other embodiments, the headrail may be mounted using brackets attached to side jambs of an architectural opening. Accordingly, the description below is intended to provide a description of only one embodiment of the present invention.

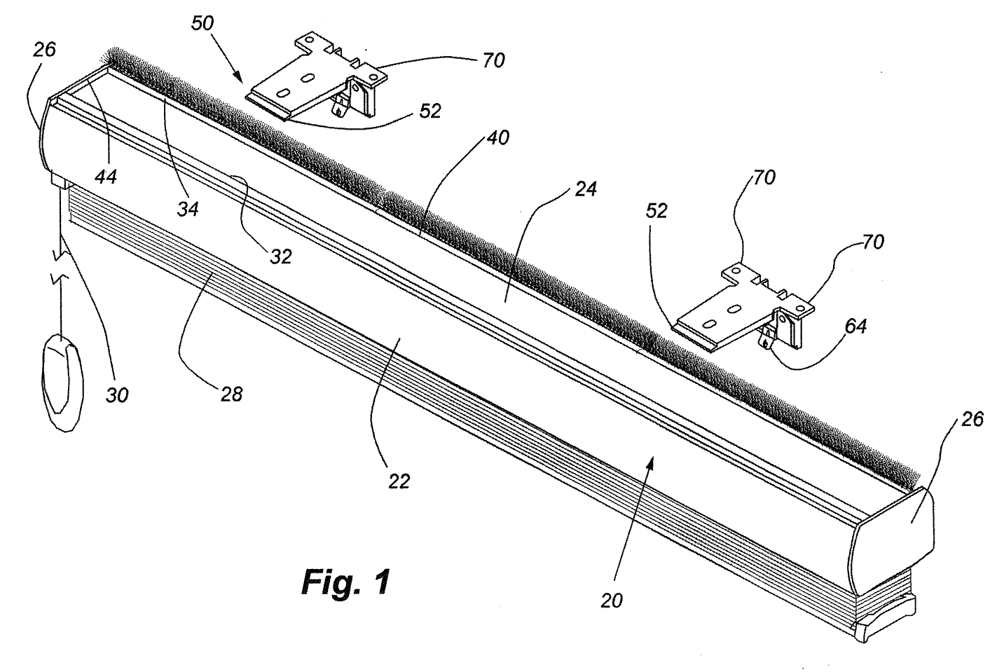

FIG. 1 illustrates an exemplary embodiment of a headrail 20 for an architectural covering in accordance with the present invention. The headrail 20 includes a front surface 22 and a top surface 24, as well as opposing end caps 26 that are removably attached to the ends of the headrail 20. FIG. 1 further illustrates a collapsible shade product 28 and a pull string 30 used to raise and lower the shade product 28. The specific type of shade product 28 may include, but is not limited to, blinds or shades. As those with skill in the art will appreciate, the specific type of shade product 28 may vary in different embodiments of the present invention. Shade product 28 is not described further herein.

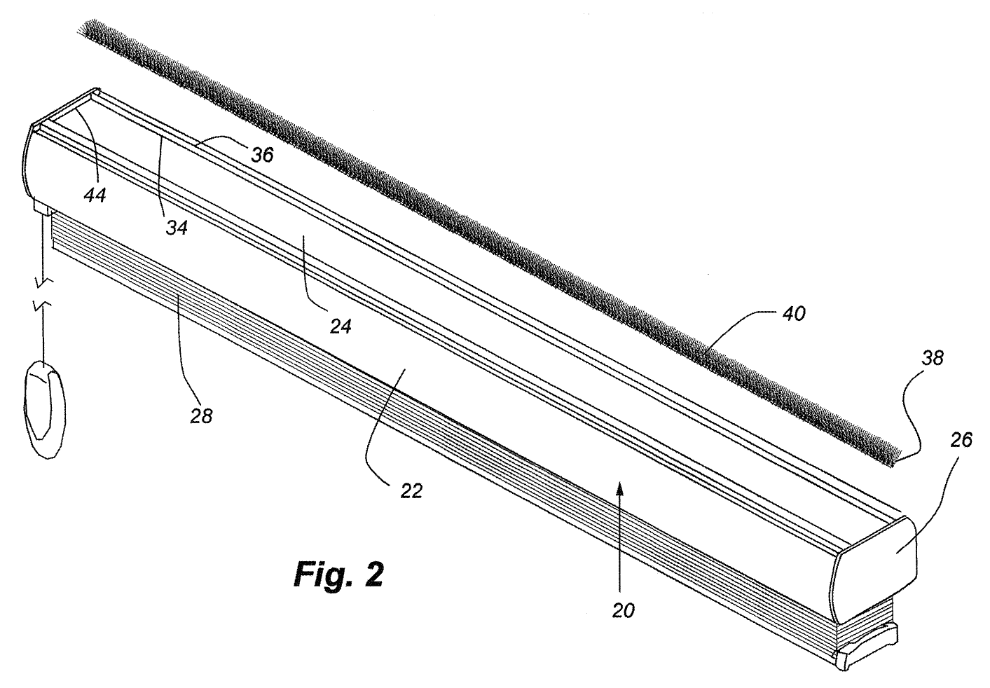

The top surface 24 of the headrail 20 includes a raised lip portion 32 extending along a forward portion of the headrail 20, wherein the lip portion 32 engages a protruding tab 52 of one or more brackets 50, as described in greater detail below. A rear portion of the top surface 24 of the headrail 20 includes a tray 34 defining a channel 36 (FIG. 2) adapted to receive a light-blocking strip 38. In the embodiment shown in FIG. 1 and FIG. 2, the light-blocking strip 38 includes a plurality of bristles 40 extending vertically there from. In other embodiments, the light-blocking strip 38 does not include bristles 40. For example, in one embodiment, strip 38 is made from a flexible material that can be easily deflected and compressed when installed within an architectural opening.

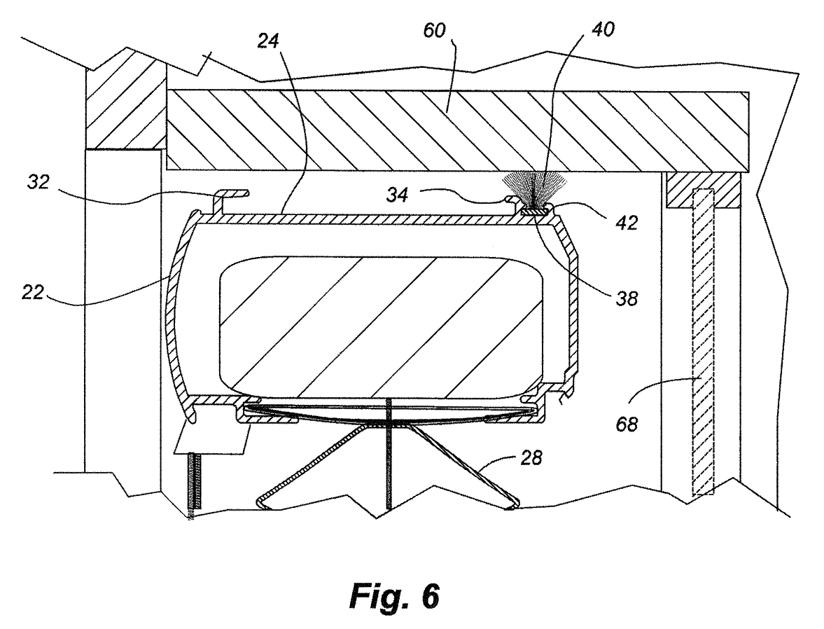

As best shown in the section view of FIG. 6, tray 34 includes an upper flange 42 that retains the light-blocking strip 38 while allowing for lateral movement of the strip 38 within the tray 34. In other words, light-blocking strip 38 is attached to the headrail 20 using tray 34 and upper flange 42. The strip 38 is, in embodiments, fed into the channel 36 (FIG. 2) from one end of the headrail 20 (e.g., by first removing one of the end caps 26 and then sliding the strip 38 along the length of the channel 36 before reattaching the end cap 26). Each end cap 26 extends slightly above the top surface 24 of the headrail 20 to define an end wall 44 (FIG. 2) at each end of the channel 36 which prevents movement of the strip 38 within the channel 36 after the end caps 26 are attached. The end caps assist in keeping strip 38 attached to headrail 20.

In some embodiments, in addition to channel 36 and end caps 26, strip 38 is also held in place using an adhesive material within channel 36. The adhesive material may be applied to strip 38 and/or top surface 24, and in embodiments is made of material particularly suited for adhering strip 38 to stop surface 24. In other embodiments, an adhesive material is used instead of channel 36 and end caps 26. That is, strip 38 is held in place only by the adhesive material and not any channels or end caps.

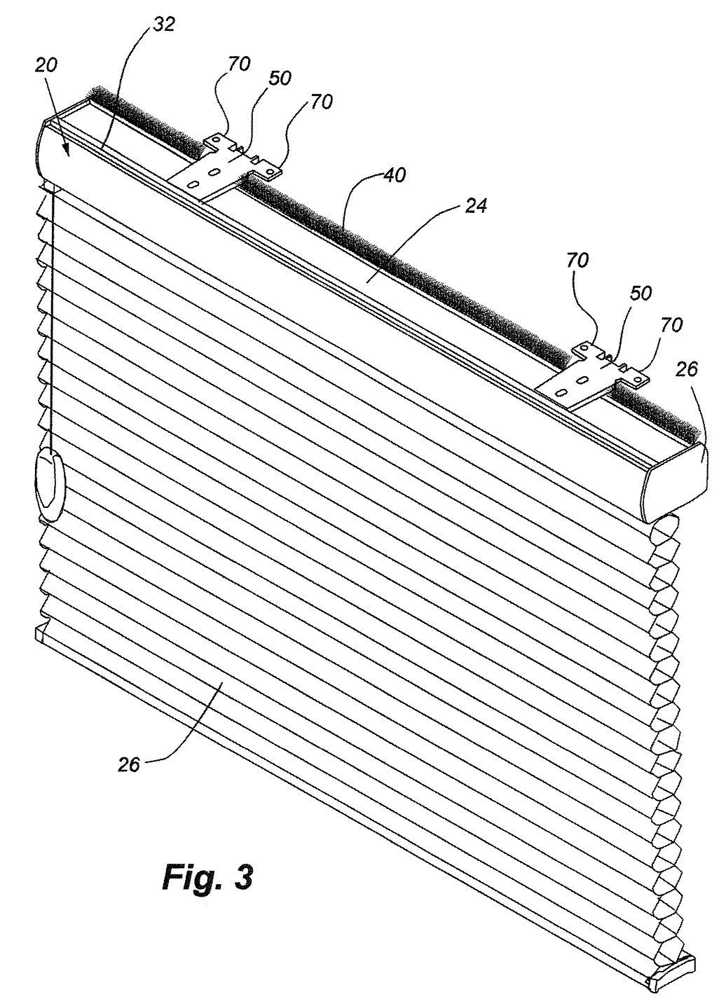

In those embodiments that include the light-blocking bristles 40, the bristles 40 may be durable and can be made from a number of natural or synthetic materials, including but not limited to animal hair, rubbers, polymers, and combinations thereof. The material for making bristles 40 is in embodiments resistant to mildew, as the light-blocking strip 38 may be exposed to moisture, e.g., from a leaking window or condensation from a window. In other embodiments, the bristles 40 are made from a material that is resistant to degradation from UV rays as the light-blocking strip 38 may be exposed to UV rays from the sun for long periods of time. The bristles 40 are in embodiments pliable and resilient in order to accommodate irregular gaps between the headrail 20 and a top beam, as well as to completely surround the attachment brackets 50 (FIG. 1) when the headrail 20 is installed within a window frame or other architectural opening, as shown in FIG. 3 and described in greater detail below.

In those embodiments that do not include bristles 40, strip 38 may be made from a variety of natural or synthetic materials that are pliable and also durable. In one embodiment, the strip 38 may be made from materials similar to those used to make weather stripping. In other embodiments, strip 38 may be made from a woven or non-woven textile material. As those with skill in the art will appreciate, strip 38 is not limited to any particular type of material and may be made using any material without departing from the scope of the present invention.

FIG. 3 illustrates the attachment of a pair of brackets 50 to the headrail 20, where each bracket 50 compresses a portion of the light-blocking strip (e.g., a portion of the bristles 40 lie underneath the bracket 50). However, as described in greater detail below with respect to FIG. 6, the localized compression or crushing of the bristles 40 does not deter from the light-blocking ability of the strip 38 and the associated headrail 20 because the brackets 50 themselves similarly serve to block external light from passing between a top beam of the architectural opening (e.g., the top window jamb) and the top surface 24 of the headrail 20.

It should be understood that in some embodiments, headrail 20 may be mounted into an architectural opening using different brackets. For example, in one embodiment headrail 20 may be mounted into an architectural opening using side brackets. The side brackets may be mounted on side jambs of the architectural opening. In these embodiments, the strip 38 would be substantially uncompressed along its entire length.

Referring again to FIG. 3, in some embodiments, headrail 20 may include a plurality of light-blocking strips instead of the single light-blocking strip 38. As shown in FIG. 3, strip 38 is compressed by brackets 50, and as mentioned above the brackets 50 themselves serve to block light from passing between the top beam of an architectural opening and the top surface 24 of the headrail 20. Accordingly, in some embodiments instead of compressing the light-blocking strip 38, headrail 20 will include three separate light-blocking strips. A first strip extending from one end of the headrail 20 to a first side of a first bracket. The second strip extending from a second side of the first bracket to a first side of a second bracket. A third strip extending from a second side of the second bracket to a second end of the headrail 20. As those with skill the art will appreciate, other embodiments may include a different number of light-blocking strips. For example, the number of strips may depend upon the number of brackets 50.

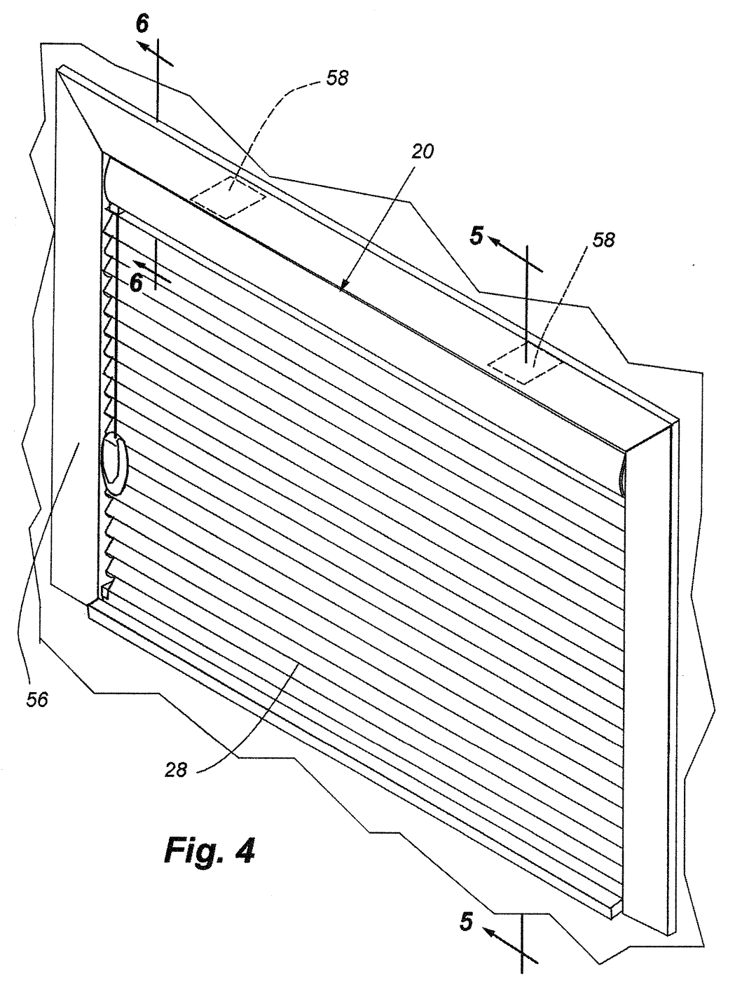

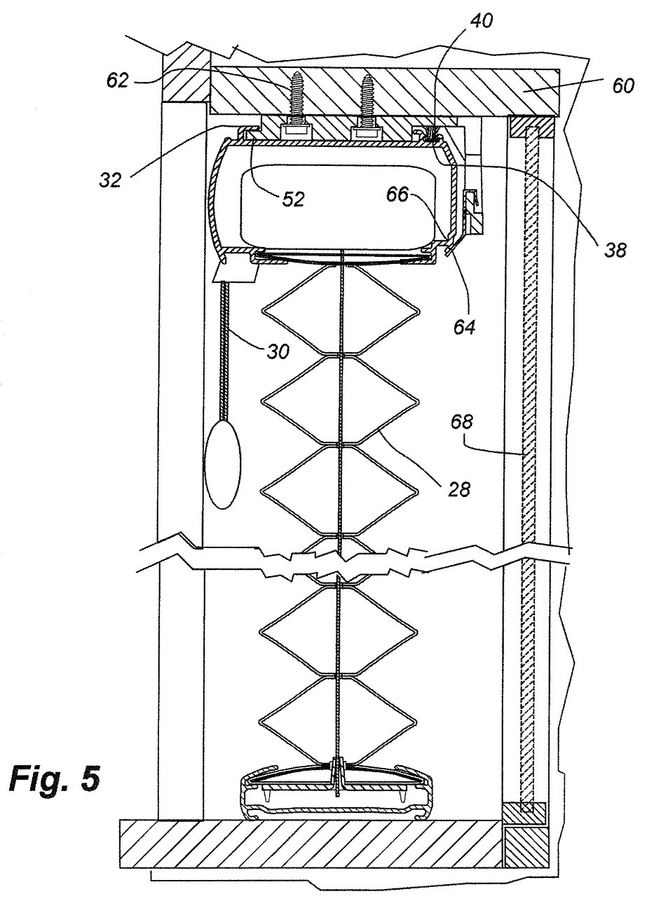

FIG. 4 illustrates the headrail 20 and shade product 28 of FIG. 3 installed within a window frame 56, where a pair of dashed squares 58 indicate the position of the brackets 50 attached to a top beam 60 (FIGS. 5 and 6) of the window frame 56. FIGS. 5 and 6 show the details of the headrail 20 installed within the frame at sections taken both through and away from the mounting brackets 50, respectively.

The section view of FIG. 5 illustrates the connection of one of the mounting brackets 50 to the top beam 60 via mounting screws 62, although alternative methods of mounting the headrail 20 to the top beam 60 may be utilized without departing from the scope of the present invention. The mounting bracket 50 includes the forward tab 52 that engages the lip portion 32 of the headrail 20 (as described above with respect to FIG. 1). Additionally, in one embodiment, a rear portion 64 of the mounting bracket 50 extends along a rear side of the headrail 20 and engages a bottom lip 66 on the headrail 20, as shown in FIG. 5, to releasably secure the headrail 20 within the bracket 50. Due to the thickness of the top portion of the bracket 50 (i.e., the portion that accepts the mounting screws 62), the top surface 24 of the headrail 20 extends down below the bottom surface of the window jamb 60, thereby causing a standoff or gap between the headrail 20 and the top beam 60 (as best seen in FIG. 6). The gap extends along the entire length of the headrail 20 shown in FIG. 4, except for the locations of the brackets 50 as indicated by the dashed squares 58. The presence of the gap potentially allows light from the window 68 to pass between the headrail 20 and the top beam 60 of the window frame. As described above, such potential light leakage is undesirable, particularly in those cases where the shade product 28 is designed for total light blockage.

The enlarged section view of FIG. 6 best illustrates the light-blocking effect of strip 38 that includes, in one embodiment, bristles 40 extending upward from the strip 38. In particular, the bristles 40 tend to block substantially all of the light that might otherwise pass through the window 68 and over the top surface 24 of the headrail 20. The pliable nature of the bristles 40 allows the light-blocking strip to conform to the available space between the headrail 20 and the window jamb 60. Thus, even in those cases where the beam 60 may not be perfectly straight (e.g., where the beam is warped/wavy, not level, or has otherwise cracked or split due to exposure to sunlight and moisture), the bristles 40 can conform and fill in the gap. In an embodiment, the bristles 40 have a length that is greater than the thickness of the mounting bracket 50 to account for the potential gaps or varying dimensions of the window frame 60. In one embodiment, the bristles 40 have a vertical length that extends about 0.3 inches (and more specifically about 0.28 inches in one embodiment) above the top surface 24 of the headrail 20.

In those embodiments in which strip 38 does not include bristles 40, strip 38 extends beyond the top surface 24 of the headrail 20. As described above, the strip 38 is preferably made from a material that can be easily compressed between the top surface 24 of the headrail 20 and the top beam 60 to conform and fill in the gap. In an embodiment, the strip extends about 0.3 inches (and more specifically about 0.28 inches in one embodiment) above the top surface 24 of the headrail 20.

Returning to the section view of FIG. 5, it is apparent that a bottom surface of the bracket 50 contacts and compresses a portion of the bristles 40 along the light-blocking strip 38. FIG. 3 also illustrates the compression of a segment of the bristles 40 underneath each bracket 50 once the brackets are secured to the headrail 20. However, FIG. 3 further demonstrates that the bristles 40 immediately adjacent to each of the brackets 50 are not substantially impacted by the presence of the brackets 50 (i.e., the bristles 40 continue to extend vertically upward to block the window light on either side of the brackets 50). Thus, the pliable and resilient bristles 40 allow the light-blocking strip 38 to substantially seal the entire gap or standoff between the top beam 60 and the top surface 24 of the headrail 20. In particular, the bristles 40 tightly surround the brackets 50 and prevent even small areas of light leakage around the brackets 50. Furthermore, the resilient nature of the bristles 40 allows for the brackets 50 to be attached and removed from the headrail 20 numerous times without permanently damaging or deforming the light-blocking strip 38 (such as might occur during a typical installation of the headrail 20 and associated shade product 28).

While individual bristles 40 are shown in the FIGS. 1-6, the light-blocking strip 38 may employ alternative means for sealing the light gap between the top beam 60 and the top surface 24 of the headrail 20. Indeed, rather than inserting the strip 38 within a tray 34 along the top of the headrail, the strip 38 and gap-filling material may be formed integrally with the headrail 20. In one example, the headrail 20 may comprise a plastic extrusion, and the light-blocking strip 38 may be co-extruded from a plastic material having a lower durometer (e.g., a softer plastic material akin to a windshield wiper blade). In this embodiment, where the gap-filling material is formed from a single extrusion, the attachment of the brackets 50 may locally compress the gap-filling material and allow minor light leakage on either side of the brackets 50. However, in one embodiment, the brackets 50 include laterally-extending light shields 70 (FIGS. 1 and 3) that extend outward from each side of the bracket and are positioned behind the light-blocking strip 38 to help fill the gap (and thus block light leakage) in the area where the bracket 50 compresses the light-blocking strip 38. Thus, in those instances when the bracket 50 locally compresses the light-blocking strip 38, the design of the bracket 50 complements the strip 38 to substantially eliminate all light leakage above the headrail 20.

While a number of embodiments have been described for purposes of this disclosure, various changes and modifications may be made which are well within the scope of the present invention. For example, alternative materials and dimensions may be used for the light-blocking strip 38, as described above. Materials used for weather stripping exterior doors may similarly be used to seal the light gap caused by the standoff between the headrail and the top beam or jamb of the architectural opening. Furthermore, numerous other changes may be made which will readily suggest themselves to those skilled in the art and which are encompassed in the scope of the present invention.

We claim:

1. A headrail for an architectural covering, the headrail comprising:
a top surface; and
a light-blocking strip attached to a rear portion of the top surface, wherein at least a portion of the light-blocking strip extends above the top surface.

2. The headrail of claim 1, wherein the light-blocking strip comprises a plurality of bristles.

3. The headrail of claim 2, wherein the top surface comprises a tray defining a channel adapted to receive the light blocking strip.

4. The headrail of claim 3, wherein the tray includes a flange that holds the light-blocking strip while allowing for lateral movement of the light-blocking strip.

5. The headrail of claim 4, further comprising two opposing end caps that are removably attached to ends of the headrail.

6. The headrail of claim 5, wherein at least a portion of each end cap extends above the top surface of the headrail to define an end wall at each end of the channel, wherein each end wall prevents lateral movement of the light-blocking strip within the channel.

7. The headrail of claim 1, wherein the light-blocking strip is attached to the headrail using an adhesive material.

8. The headrail of claim 1, further comprising a first mounting bracket attached to the top surface of the headrail such that a first portion of the light-blocking strip is compressed between the top surface of the headrail and the first mounting bracket.

9. The headrail of claim 8, further comprising a second mounting bracket attached to the top surface of the headrail such that a second portion of the light-blocking strip is compressed between the top surface of the headrail and the second mounting bracket.

10. The headrail of claim 8, wherein the first mounting bracket comprises a forward tab.

11. The headrail of claim 10, further comprising a raised lip that extends above the top surface and engages the forward tab of the first mounting bracket.

12. The headrail of claim 11, further comprising a bottom lip that engages a rear portion of the first mounting bracket.

13. An architectural covering comprising:
a headrail;
a light-blocking strip attached to the headrail, the light blocking strip comprising a plurality of bristles, wherein at least a portion of the bristles extends above a top surface of the headrail; and
a collapsible shade product attached to the headrail.

14. The architectural covering of claim 13, wherein the light blocking strip is attached to a rear portion of the top surface of the headrail.

15. The architectural covering of claim 14, wherein the rear portion of the top surface of the headrail comprises a tray defining a channel adapted to receive the light-blocking strip.

16. The architectural covering of claim 15, wherein the tray includes a flange that holds the light-blocking strip while allowing for lateral movement of the light-blocking strip.

17. The architectural covering of claim 13, further comprising two opposing end caps that are removably attached to ends of the headrail, wherein each end cap extends above the top surface of the headrail to define an end wall that prevents lateral movement of the light-blocking strip within the channel.

18. A headrail for an architectural covering, the headrail comprising;
a light-blocking strip attached to the headrail, the light blocking strip comprising a plurality of bristles, wherein at least a portion of the bristles extends above a top surface of the headrail; and
a tray defining a channel adapted to receive the light-blocking strip, wherein the tray includes a flange that holds the light-blocking strip.

19. The headrail of claim 18, further comprising two opposing end caps that are removably attached to ends of the headrail, wherein each end cap extends above the top surface of the headrail to define an end wall at each end of the channel that prevents lateral movement of the light-blocking strip within the channel.

20. The headrail of claim 19, wherein the bristles extend about 0.30 inches above the top surface of the headrail.
